(19) United States
(12) Patent Application Publication
(10) Pub. No.: US 2011/0148845 A1
(43) Pub. Date: Jun. 23, 2011

(54) DRIVING METHOD OF A DISPLAY DEVICE AND DISPLAY DEVICE

(75) Inventor: Hirokata UEHARA, Kawasaki (JP)

(73) Assignee: FUJITSU LIMITED, KAWASAKI-SHI (JP)

(21) Appl. No.: 12/966,188

(22) Filed: Dec. 13, 2010

(30) Foreign Application Priority Data
Dec. 18, 2009 (JP) 2009-287961

(51) Int. Cl. G06F 3/038

(52) U.S. Cl. 345/212

(57) ABSTRACT

A driving method of a display device includes: supplying a first drive voltage from a first circuit, which is driven using a first power-supply voltage from a first power source, and a second drive voltage from a second circuit, which is driven using a second power-supply voltage from a second power source that is lower than the first power-supply voltage; causing a driver circuit section that drives a display element to charge, using the second drive voltage, a display element in a non-selected region in a display element section that includes a plurality of display elements; maintaining a voltage of the display element in the non-selected region, using the second drive voltage.

### CROSS-REFERENCE TO RELATED APPLICATIONS

This application is based upon and claims the benefit of priority of the prior Japanese Patent Application No. 2009-287961, filed on Dec. 18, 2009, the entire contents of which are incorporated herein by reference.

### FIELD

The present invention relates to a driving method of a display device and a display device.

### BACKGROUND

In recent years, the development of a display device called rewritable electronic paper or the like has been promoted in which display content can be maintained even if the display device is powered off. One display method performed in the electronic paper is a display method that utilizes a liquid-crystal composition in which a cholesteric phase is formed. Examples of the liquid-crystal composition in which a cholesteric phase is formed include cholesteric liquid crystals. The cholesteric liquid crystals are also referred to as chiral nematic liquid crystals. The cholesteric liquid crystals form a cholesteric phase in which molecules of the nematic liquid crystal are in the form of a helix by adding a chiral additive into a nematic liquid crystal. The cholesteric liquid crystals have excellent characteristics, such as a semi-permanent display maintaining function (memory function), a vivid color display characteristic, a high contrast ratio, and a high resolution characteristic.

A display device that utilizes the cholesteric liquid crystals performs multi-color display using a cholesteric liquid crystal layer that selectively reflects light of various wavelengths. By controlling voltages applied to display elements, the display device that utilizes such cholesteric liquid crystals can be controlled so that the display device is put into any one of a planar state which reflects light of a specific wavelength, a focal conic state which transmits light, and an intermediate state with a property between the planar state and the focal conic state.

In the display device that utilizes the cholesteric liquid crystals, a display element section (or display panel) in which display elements are disposed in a matrix is driven using a segment driver and a common driver. The segment driver outputs an ON/OFF voltage that corresponds to image data of one line to the display element section, and the common driver outputs an ON/OFF voltage that corresponds to a selected-line position to the display element section. Since the display device that utilizes the cholesteric liquid crystals has the memory function that can maintain a display image, it is necessary to erase a previous display image before rewriting the display image. Since output voltages of the segment driver and the common driver differ between a drawing operation for a display image and an erasing operation for a display image, it is necessary for a voltage supply circuit to supply at least two types of voltages the electrical potentials of which are different from each other to the segment driver and the common driver.

A drawing unit of a display element section that has a simple matrix structure is one line, and the remaining lines form a non-selected region that is not used for drawing. Among drive voltages supplied to the display element section at the time of drawing, drive voltages supplied to a selected line are, for example, ±24 volts (V) or ±12 V, and drive voltages supplied to the non-selected region are, for example, ±6 V. Since the display device that utilizes the cholesteric liquid crystals has a structure in which display elements that are capacitive loads are disposed in a matrix, the drive voltages supplied to the non-selected region are low voltages compared with the drive voltages supplied to the selected line. However, since the non-selected region occupies a considerable amount of the display area of the display element section, the power consumption of the non-selected region is dominant in the power consumption of the display element section. In addition, since a liquid crystal is driven using an alternate-current drive method, polarity inversion is necessary for the drive voltages.

On the other hand, in order to supply, for example, five drive voltages such as 24 V, 18 V, 12 V, 12 V, and 6 V, the voltage supply circuit typically includes a plurality of operational amplifiers that use a power-supply voltage from a common power source. Therefore, even if drive voltages supplied to the non-selected region are, for example, ±6 V, a voltage of 25 V from the common power source that the plurality of operational amplifiers use is used as the power-supply voltage. As a result, drive power used for driving the display element section increases in proportion to the display area of the display element section.

Namely, in a display device of the related art, which has a memory function, the drive power used for driving the display element section increases in proportion to the display area of the display element section, and hence it is difficult to reduce the power consumption of the display device.

An example of the related art is Japanese Unexamined Patent Application Publication No. 2009-251453.

### SUMMARY

According to an aspect of the invention, a driving method of a display device includes: supplying a first drive voltage from a first circuit, which is driven using a first power-supply voltage from a first power source, and a second drive voltage from a second circuit, which is driven using a second power-supply voltage from a second power source that is lower than the first power-supply voltage; causing a driver circuit section that drives a display element to charge, using the second drive voltage, a display element in a non-selected region in a display element section that includes a plurality of display elements; maintaining a voltage of the display element in the non-selected region, using the second drive voltage; charging the display element by firstly inverting a polarity of image data supplied to the display element section, in a time between application of a negative polarity voltage to the display element section and application of a positive polarity voltage to the display element section; and secondly inverting the polarity of the image data firstly inverted.

According to another aspect of the invention, a display device includes: a display element section including display elements disposed in a matrix; a driver circuit section to drive the display element section on a basis of image data and a first drive voltage; a voltage supply circuit including a first circuit, which is driven using a first power-supply voltage from a first power source, and a second power-supply voltage from a second circuit, which is driven using a second power-supply voltage from a second power source that is lower than the first power-supply voltage, and to supply the drive voltage to the driver circuit section; and an inverting circuit section to input the image data to the driver circuit section, the driver circuit section charges, using a second drive voltage from the second circuit, a display element in a non-selected region in the display element section, and maintains a voltage of the display element in the non-selected region, using the second drive voltage; and the inverting circuit section charges the display element for which a polarity of the image data supplied to the display element section is firstly inverted, in a time between application of a negative polarity voltage to the display element section and application of a positive polarity voltage to the display element section, and secondly inverts the polarity of the image data firstly inverted.

The object and advantages of the invention will be realized and attained at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a display device in an embodiment of the present invention;

FIGS. 2A to 2C are diagrams illustrating an example of a drive operation for a display element section;

FIGS. 3A and 3B are block diagrams illustrating examples of configurations of a segment driver and a common driver;

FIGS. 4A and 4B are diagrams illustrating output voltages of the segment driver and the common driver;

FIGS. 5A and 5B are diagrams illustrating examples of output voltages of the segment driver and the common driver;

FIG. 6 is a diagram illustrating examples of polarities of output voltages of the segment driver and the common driver;

FIGS. 7A and 7B are diagrams illustrating examples of output voltages of a multiple voltage generation section;

FIG. 8 is a diagram illustrating a non-selected region in the display element section;

FIG. 9 is a diagram illustrating the display element section having a structure in which display elements are disposed in a matrix;

FIG. 10 is a diagram illustrating an example of an interior portion of the segment driver or the common driver;

FIG. 11 is a diagram illustrating another example of the multiple voltage generation section;

FIG. 12 is a timing chart illustrating an operation performed in the display device;

FIG. 13 is a diagram illustrating the display element section in a first phase;

FIG. 14 is a diagram illustrating the display element section in a second phase;

FIG. 15 is a diagram illustrating the display element section in a third phase;

FIG. 16 is a block diagram illustrating an example of a display device in another embodiment of the present invention; and

FIG. 17 is a diagram illustrating another example of the multiple voltage generation section.

### DESCRIPTION OF EMBODIMENTS

A voltage supply circuit that supplies a plurality of drive voltages to a driver circuit section includes a first circuit, which is driven using a first power-supply voltage from a first power source, and a second circuit, which is driven using a second power-supply voltage from a second power source that is lower than the first power-supply voltage. Charging of a display element (or a pixel) in a non-selected region in a display element section is performed using a first drive voltage from the first circuit, and, after that, a voltage of the display element in the non-selected region is maintained using a second drive voltage from the second circuit. In addition, a driving method is adopted in which charging of the display element for which a polarity of the image data supplied to the display element section is firstly inverted is performed, in a time between application of a negative polarity drive voltage to the display element section and application of a positive polarity drive voltage to the display element section, and the polarity of the image data firstly inverted is secondly inverted.

According to the driving method, positive-polarity electric charge can be applied to the display element in the non-selected region with the negative polarity of an applied voltage being maintained. Therefore, driving of the display element in the non-selected region is performed using the second drive voltage that is driven using the second power-supply voltage that supplies the lower power-supply voltage, and many of the display elements in the display element section are driven using the second drive voltage. Therefore, the power consumption of the display device can be reduced.

Individual embodiments of a driving method and a display device, which are disclosed, will be described with reference to figures, hereinafter.

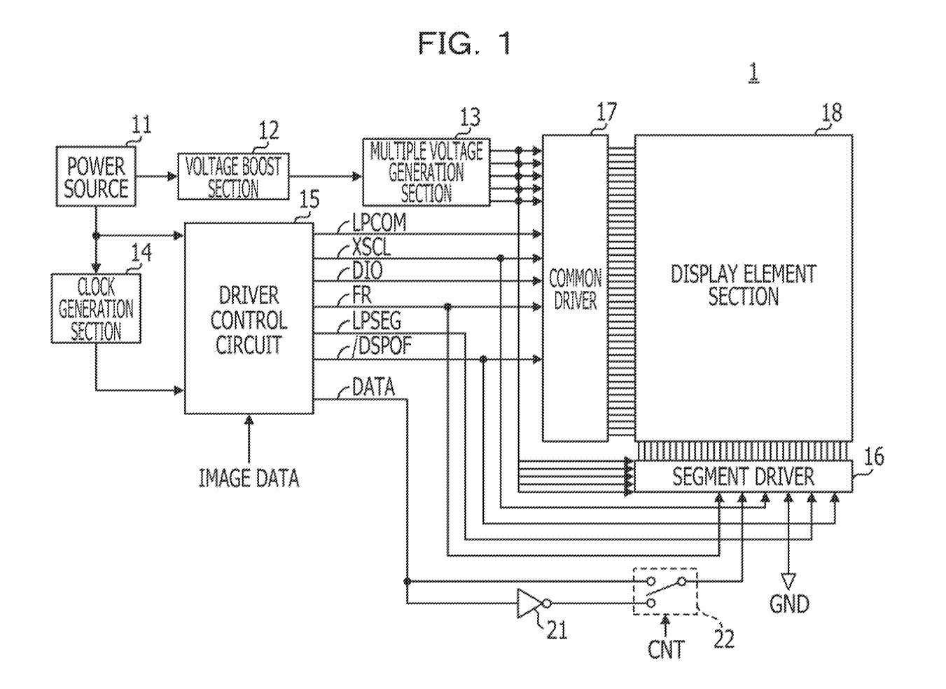

FIG. 1 is a block diagram illustrating an example of a display device in an embodiment of the present invention. For example, a display device 1 illustrated in FIG. 1 has a memory function, and, in the embodiment, is a color display device that uses cholesteric liquid crystals.

The display device 1 includes a power source 11, a voltage boost section 12, a multiple voltage generation section 13, a clock generation section 14, a driver control circuit 15, a segment driver 16, a common driver 17, a display element section (or display panel) 18, an inverter circuit 21, and a switch circuit 22. The inverter circuit 21 and the switch circuit 22 form an inverting circuit section. In response to a switching control signal CNT that is input to the switch circuit 22 from the driver control circuit 15 or an external device (not illustrated) such as a host device or the like, the inverting circuit section inputs image data to the segment driver 16 without or with the polarity of the image data being inverted. As described later, the inverting circuit section charges the display element by inverting the polarity of image data supplied to the display element section 18, in a time between application of a negative polarity voltage to the display element section 18 and application of a positive polarity voltage to the display element section 18, and inverts the polarity of the image data again.

The power source 11 outputs, for example, a power-supply voltage ranging from 3 V to 5 V. The voltage boost section 12 includes a regulator such as a DC-DC converter or the like, and boosts the power-supply voltage from the power source 11 to, for example, a voltage ranging from 24 V to 40 V. As the voltage boost section 12 may include a regulator, a typical integrated circuit (IC) can be used. Since such an IC has a function that allows a boosted voltage to be adjusted by setting a feedback voltage, one of a plurality of voltages generated by voltage dividing or the like that uses resistances is selected and fed back to a feedback terminal, thereby allowing the boosted voltage to be varied. The multiple voltage generation section 13 generates various kinds of voltages by resistive-dividing the boosted voltage from the voltage boost section 12, and stabilizes the various kinds of voltages generated. The various kinds of voltages generated by the multiple voltage generation section 13 are supplied as drive voltages to the segment driver 16 and the common driver 17 that form the driver circuit section in the display device 1.

The clock generation section 14 generates a clock that determines operation timing in the display device 1. The driver control circuit 15 generates various kinds of control signals on the basis of the clock and the image data, and supplies the various kinds of control signals to the segment driver 16 and the common driver 17. The driver control circuit 15 is, for example, a microcomputer, a central processing unit (CPU), a field programmable gate array (FPGA)/complex programmable logic device (CPLD) or the like.

The segment driver 16 outputs an ON/OFF voltage that corresponds to image data of one line to the display element section 18, and the common driver 17 outputs an ON/OFF voltage that corresponds to a selected-line position to the display element section 18. For example, the segment driver 16 drives 768 data lines, and the common driver 17 drives 1024 scan lines. Since pieces of data supplied to individual display elements R, G, and B are different from one another, the segment driver 16 separately drives individual data lines. The common driver 17 commonly drives R, G, and B lines. The image data inputted to the segment driver 16 is 4-bit data where, for example, a full-color original image is converted into 4096-color data of 16 tones for each of R, G, and B by an error diffusion method. For this tone conversion, a method by which a high display quality is obtained is desirable, and a blue-noise mask method or the like may be used according to the error diffusion method.

The display element section 18 has, for example, a structure which complies with an A-4 size eXtended Graphics Array (XGA) specification and in which 1024×768 display elements that use cholesteric liquid crystals are disposed in a matrix. The display element section 18 may have a structure that has suitable flexibility in accordance with an intended use, or may have a rigid structure that has no flexibility.

In the embodiment, the driver control circuit 15 outputs image data DATA to be supplied to the segment driver 16, and also outputs, as the various kinds of control signals, a data latch/scan shift signal LPCOM that indicates a scan line to be scanned by the common driver 17, a data capture clock XSCL that controls the transfer timing of the image data, a frame start signal DIO that indicates the start of a display line, a pulse polarity control signal FR that indicates the polarity inversion of voltages supplied to the segment driver 16 and the common driver 17, a data latch/scan shift signal LPSEG that indicates the update of a display line, and a driver output off signal /DSPOF that turns off the voltages supplied to the segment driver 16 and the common driver 17. Using the various kinds of control signals, the segment driver 16 and the common driver 17 cause the display element section 18 to display an image that corresponds to the image data.

In addition, in this example, since the data capture clock XSCL is not used in the common driver 17, it may not be necessary to supply the data capture clock XSCL to the common driver 17. In addition, while the frame start signal DIO is supplied to the common driver 17, a signal that corresponds to the frame start signal DIO, supplied to the segment driver 16, is fixed to a ground GND.

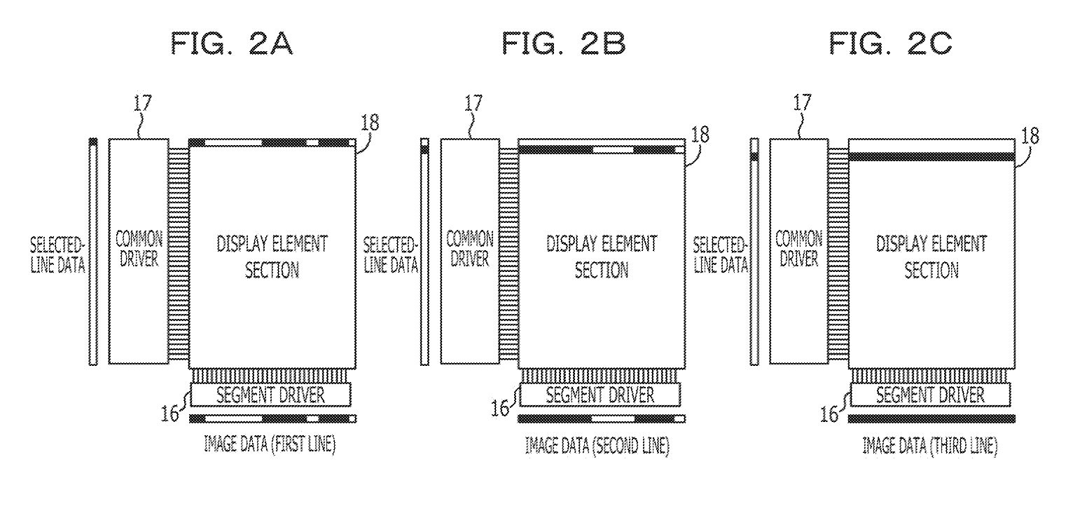

FIGS. 2A to 2C are diagrams illustrating a drive operation for the display element section 18. In this example, the segment driver 16 outputs an ON/OFF voltage in response to image data of one line, and the common driver 17 outputs an ON/OFF voltage that corresponds to a selected-line position. As illustrated in FIGS. 2A to 2C, selected display elements and the positions of the display elements are blacked out. FIG. 2A illustrates a state in which display elements that correspond to image data in a first line are selected, FIG. 2B illustrates a state in which display elements that correspond to image data in a second line are selected, and FIG. 2C illustrates a state in which display elements that correspond to image data in a third line are selected.

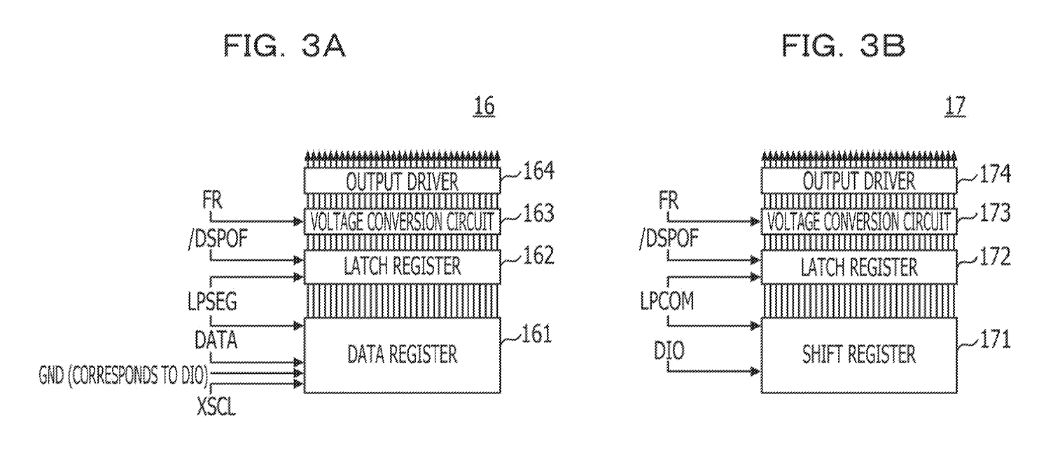

FIGS. 3A and 3B are block diagrams illustrating examples of configurations of the segment driver 16 and the common driver 17, which are used for performing a matrix display.

As illustrated in FIG. 3A, the segment driver 16 includes a data register 161, a latch register 162, a voltage conversion circuit 163, and an output driver 164. In the segment driver 16, on the basis of the data latch/scan shift signal LPSEG, image data is loaded from the data register 161 into the latch register 162. Voltages that correspond to the image data stored in the latch register 162 are converted into voltages, which are suitable for driving the display element section 18, in the voltage conversion circuit 163, and are output through the output driver 164. Since buffers for two lines, which are the data register 161 and the latch register 162, are provided, image data in a line next to the image data DATA can be stored in the data register 161 on the basis of the frame start signal DIO and the data capture clock XSCL while voltages that correspond to the image data in the latch register 162 are output. In this way, the segment driver 16 outputs ON/OFF voltages that correspond to image data of one line to the display element section 18.

As illustrated in FIG. 3B, the common driver 17 includes a shift register 171, a latch register 172, a voltage conversion circuit 173, and an output driver 174. The frame start signal DIO is shifted on the basis of the data latch/scan shift signal LPCOM, and loaded into the latch register 172. Voltages that correspond to the selected-line position stored in the latch register 172 are converted into voltages, which are suitable for driving the display element section 18, in the voltage conversion circuit 173, and are output through the output driver 174. In this way, the common driver 17 outputs ON/OFF voltages that correspond to the selected-line position to the display element section 18.

Using the segment driver 16 and the common driver 17, the display element section 18 can be scanned with respect to each line.

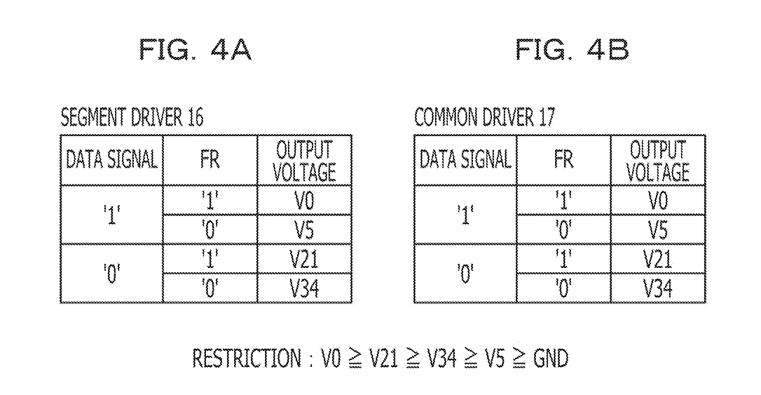

Next, a relation between the output voltages of the multiple voltage generation section 13 and the output voltages of the segment driver 16 and the common driver 17 will be described with reference to FIGS. 4A to 9.

FIGS. 4A and 4B are diagrams illustrating the output voltages of the segment driver 16 and the common driver 17. FIG. 4A illustrates an example of output voltages that correspond to a data signal and the pulse polarity control signal FR, supplied to the segment driver 16, and FIG. 4B illustrates an example of output voltages that correspond to a data signal and the pulse polarity control signal FR, supplied to the common driver 17. In the examples, any one of the output voltages of the segment driver 16 and the common driver 17 is one of voltages V0, V5, V21, and V34. In addition, in the following description, in some cases, the output voltages V21 and V34 of the segment driver 16 are indicated using V21S and V34S that are attached with “S”, respectively, and the output voltages V21 and V34 of the common driver 17 are indicated using V21C and V34C that are attached with “C”, respectively.

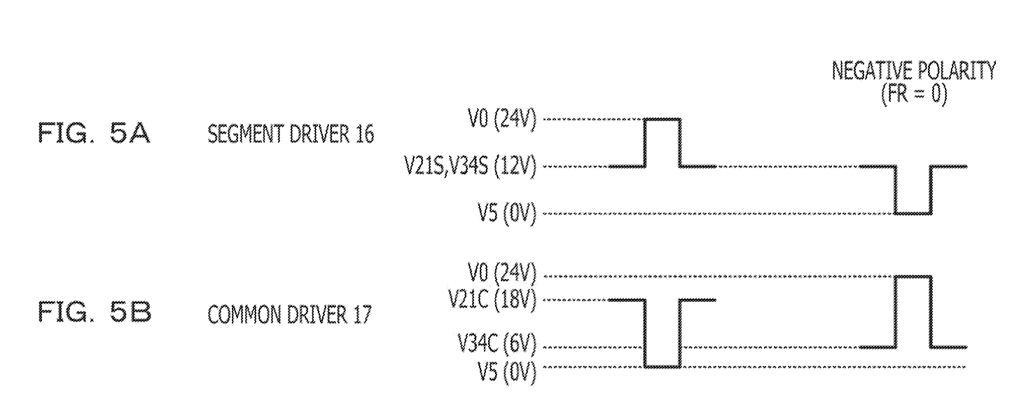

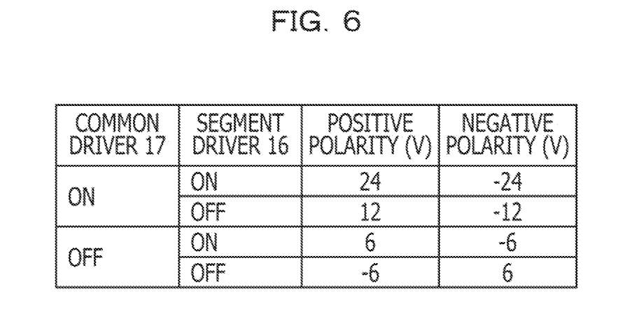

FIGS. 5A and 5B are diagrams illustrating examples of the output voltages of the segment driver 16 and the common driver 17, and FIG. 6 is a diagram illustrating examples of polarities of the output voltages of the segment driver 16 and the common driver 17. FIG. 5A illustrates the output voltages V0, V21S, V34S, and V5 of the segment driver 16, and FIG. 5B illustrates the output voltages V0, V21C, V34C, and V5 of the common driver 17. In this example, the following conditions are met: V0=24 V, V21S=V34S=12 V, V5=0 V, V21C=18 V, and V34C=6 V.

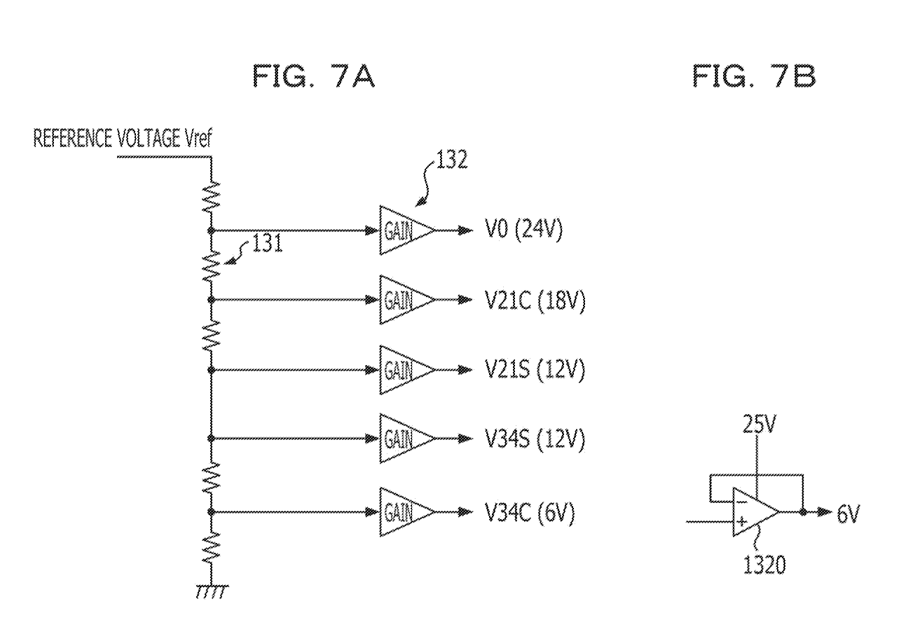

FIGS. 7A and 7B are diagrams illustrating an example of the multiple voltage generation section 13. FIG. 7A illustrates an example of the configuration of a voltage supply circuit that generates various kinds of voltages on the basis of a reference voltage Vref from the voltage boost section 12, and FIG. 7B illustrates an example of the configuration of an amplification circuit. In FIG. 7A, a resistance group 131 includes a plurality of series-connected resistances connected between the reference voltage (power source) Vref and ground (0 V), and an amplification circuit group 132 includes a plurality of amplification circuits connected to nodes that connect adjacent resistances in the resistance group 131. The voltage supply circuit in FIG. 7A supplies output voltages V0, V21C, V21S, V34S, and V34C.

The individual amplification circuits (GAIN) that form the amplification circuit group 132 includes, for example, an operational amplifier 1320 that has a connection configuration illustrated in FIG. 7B. Each operational amplifier 1320 in the amplification circuit group 132 is driven using, for example, a common power-supply voltage of 25 V. In a case in which the output current of the operational amplifier 1320 is, for example, 10 milliamperes (mA), when an output signal the voltage of which is, for example, 6 V, is output, the power consumption of each operational amplifier 1320 turn out to be 250 mW=25 V×10 mA.

In this example, when an image drawing operation is performed in the display element section 18, output voltages V0=24 V, V21S=12 V, and V34S=12 V are provided for the segment driver 16, and output voltages V0=24 V, V21C=18 V, and V34C=6 V are provided for the common driver 17. In addition, the output voltages of the segment driver 16 meet the following relation: V0≧V21S≧V34S≧V5≧0 V, and the output voltages of the common driver 17 meet the following relation: V0≧V21C≧V34C≧V5≧0 V. Namely, the output voltages of the segment driver 16 and the common driver 17 at the time of drawing meet the following relation: V0≧V21≧V34≧V5≧0 V.

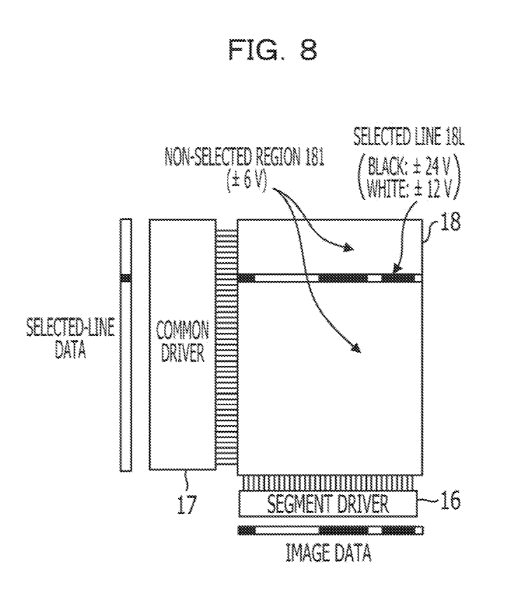

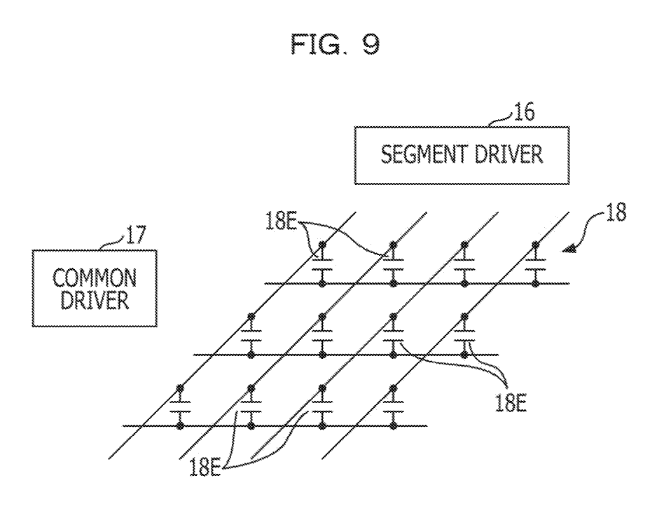

FIG. 8 is a diagram illustrating the non-selected region in the display element section 18. A drawing unit of the display element section 18 that has a simple matrix structure is one line, and the remaining lines form a non-selected region 181 that is not used for drawing. Among drive voltages supplied to the display element section 18 at the time of drawing, drive voltages supplied to a selected line 18L are, for example, ±24 V (display elements indicated with black in FIG. 8) or ±12 V (display elements indicated with white in FIG. 8), and drive voltages supplied to the non-selected region 181 are, for example, ±6 V. The display element section 18 in the display device 1 that utilizes cholesteric liquid crystals has a structure in which display elements (pixels or dots) 18E that are capacitive loads are disposed in a matrix, as illustrated in FIG. 9. FIG. 9 is a diagram illustrating the display element section 18 that has a structure in which the display elements 18E are disposed in a matrix. Therefore, the drive voltages supplied to the non-selected region 181 are low voltages compared with the drive voltages supplied to the selected line 18L. However, since the non-selected region 181 occupies a considerable amount of the display area of the display element section 18, the power consumption of the non-selected region 181 is dominant in the power consumption of the display element section 18. In addition, since a liquid crystal is driven using an alternate-current drive method, polarity inversion is used for voltages used for driving display elements in the display element section 18.

On the other hand, in order to supply, for example, five drive voltages of 24 V, 18 V, 12 V, 12 V, and 6 V, the voltage supply circuit includes a plurality of operational amplifiers 1320 that use the power-supply voltage Vref from the common power source, as illustrated in FIG. 7A. Therefore, even if drive voltages supplied to the non-selected region 181 are, for example, ±6 V, a voltage of 25 V from the common power source that the plurality of operational amplifiers 1320 use is used as the power-supply voltage. As a result, drive power used for driving the display element section 18 increases in proportion to the display area of the display element section 18.

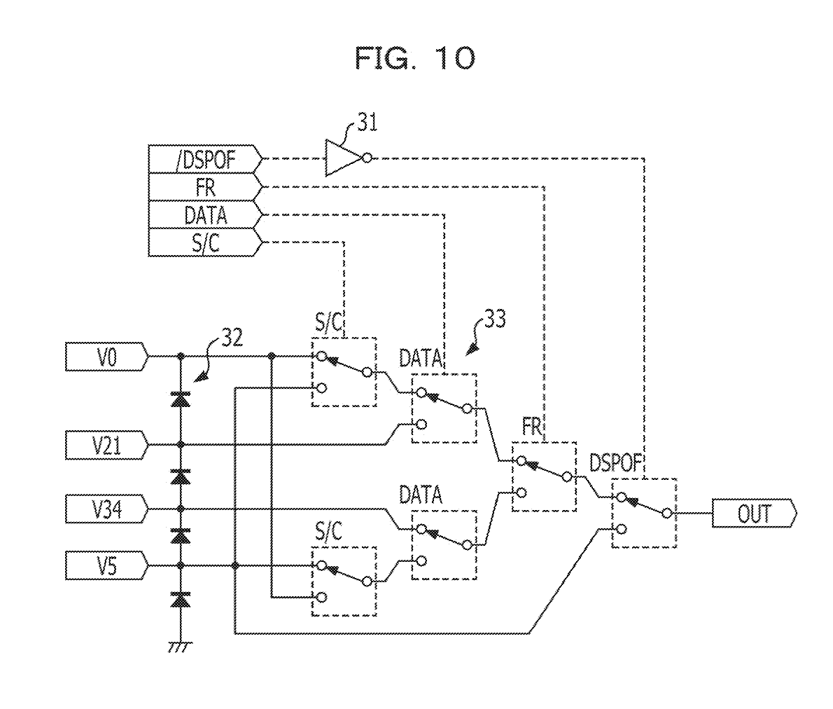

FIG. 10 is a diagram illustrating an example of an interior portion of the segment driver 16 or the common driver 17. A driver illustrated in FIG. 10 includes an inverter 31 connected as illustrated in FIG. 10, a diode group 32 formed by four protection diodes or parasitic diodes, and a switch group 33 formed by six switches. The switch group 33 includes two switches controlled by a segment/common switching signal S/C, two switches controlled by the image data DATA, one switch controlled by the pulse polarity control signal FR, and one switch controlled by the driver output off signal /DSPOF. By controlling the switches in the switch group 33, the driver outputs, as an output voltage OUT, one of voltages V0, V21, V34, and V5 from the multiple voltage generation section 13. The driver illustrated in FIG. 10 can be used as the segment driver 16 by fixing the logic level of the segment/common switching signal S/C to a first value, and can also be used as the common driver 17 by fixing the logic level of the segment/common switching signal S/C to a second value.

The output voltage of the driver illustrated in FIG. 10 meets the relation mentioned above: V0≧V21≧V34≧V5≧0 V. This is because, in the driver illustrated in FIG. 10, diodes are arranged between nodes that have electrical potentials V0, V21, V34, and V5, and hence a penetration current flows if the relation mentioned above is not met. When the relation mentioned above is not met, the driver may be damaged. In addition, even if a penetration current flows within the driver, the penetration current is generated in the driver itself, and hence there is no particular restriction such as the relation mentioned above, between the output voltage of the segment driver 16 and the output voltage of the common driver 17.

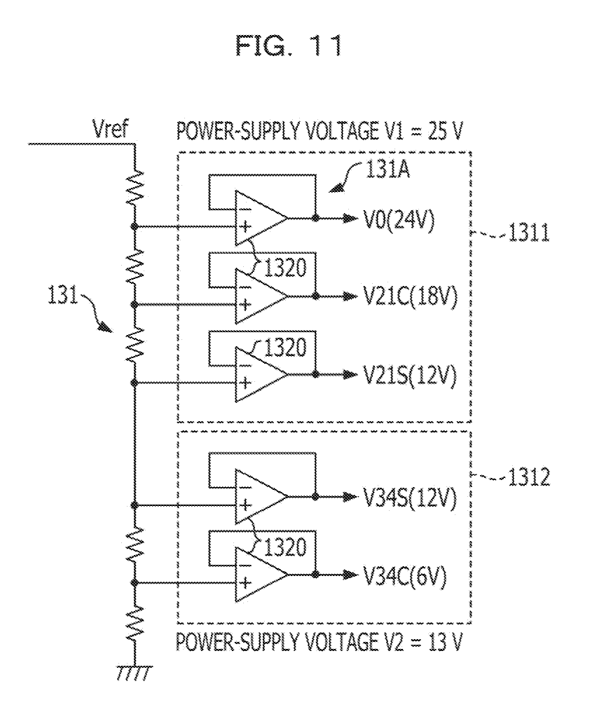

Next, another example of the multiple voltage generation section 13 that can reduce the power consumption of the display device 1 will be described. FIG. 11 is a diagram for explaining the other example of the multiple voltage generation section 13.

FIG. 11 illustrates a voltage supply circuit that generates various kinds of voltages on the basis of the reference voltage Vref from the voltage boost section 12, in the multiple voltage generation section 13. The voltage supply circuit includes a resistance group 131 and an amplification circuit group 131A that includes amplification circuit sections 1311 and 1312. The resistance group 131 includes a plurality of series-connected resistances connected between the reference voltage (power source) Vref and ground (0 V). The amplification circuit sections 1311 and 1312 include a plurality of amplification circuits 1320 that are connected to nodes that connect adjacent resistances in the resistance group 131. Each amplification circuit 1320 is formed using an operational amplifier.

The amplification circuit 1320 (namely, an operational amplifier) in the amplification circuit section 1311 is driven using a power-supply voltage V1 that has, for example, a voltage of 25 V. On the other hand, the amplification circuit 1320 (namely, an operational amplifier) in the amplification circuit section 1312 is driven using a power-supply voltage V2 that has, for example, a voltage of 13 V. The power-supply voltages V1 and V2 (V1>V2) are supplied from power sources different from each other. The amplification circuit section 1311 outputs drive voltages V0=24 V, V21C=18 V, and V21S=12 V. On the other hand, the amplification circuit section 1312 outputs drive voltages V34S=12 V and V34C=6 V. In this example, there is a potential difference of 6 V between the drive voltages V0, V21C, and V21S, and there is a potential difference of 6 V between the drive voltages V34S and V34C.

In this way, in the multiple voltage generation section 13 in FIG. 11, as power sources for driving amplification circuits (namely, operational amplifiers) 1320 in the amplification circuit group 131A, two separate power sources that have a high voltage of 25 V and a low voltage of 13 V, respectively are used. While, in this example, the voltages of two types of power-supply voltages are 25 V and 13 V in view of a margin for drive voltages, the voltage values thereof are not limited to the example. When a so-called rail-to-rail type operational amplifier that can output a voltage ranging to the power-supply voltage is used, two types of power-supply voltages in a case in which the drive voltages V0, V21C, V21S, V34S, and V34C, the voltage values of which are as mentioned above, are output may be, for example, 24 V and 12 V.

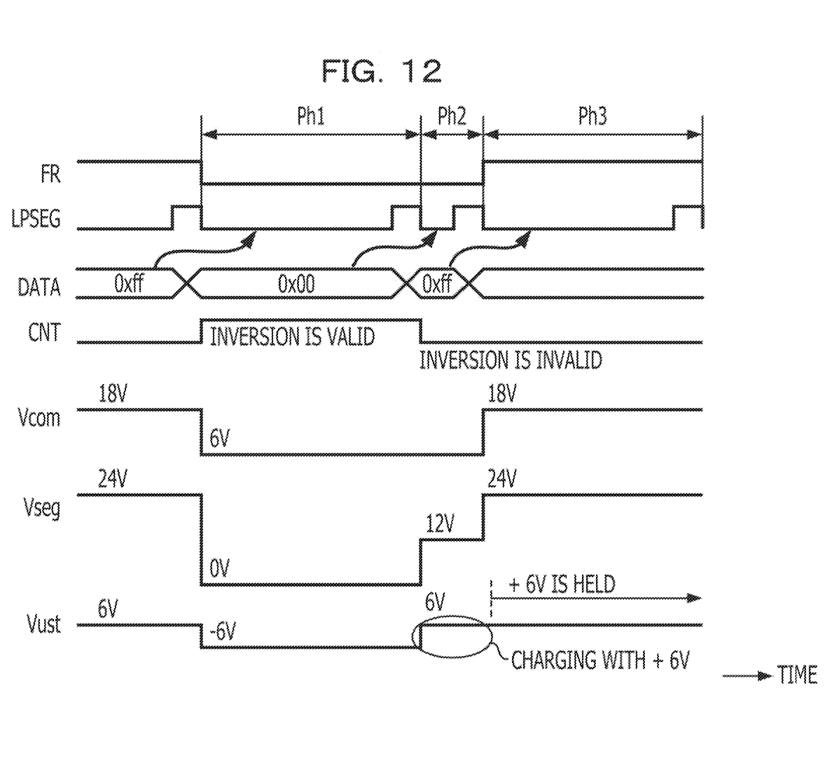

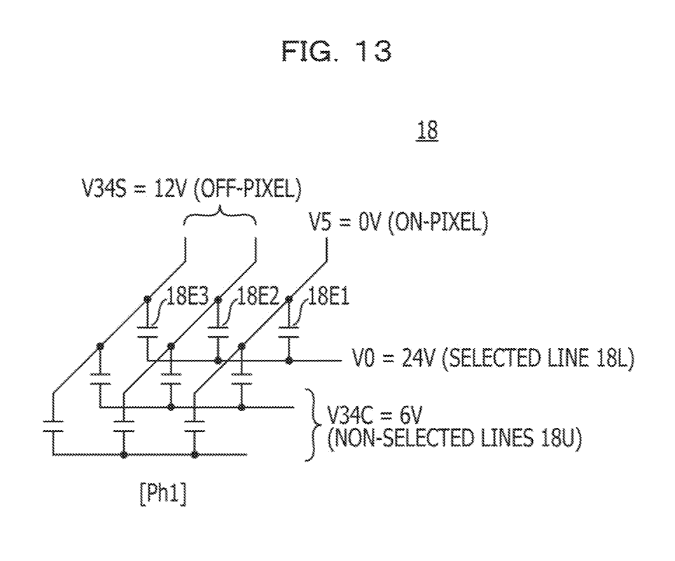

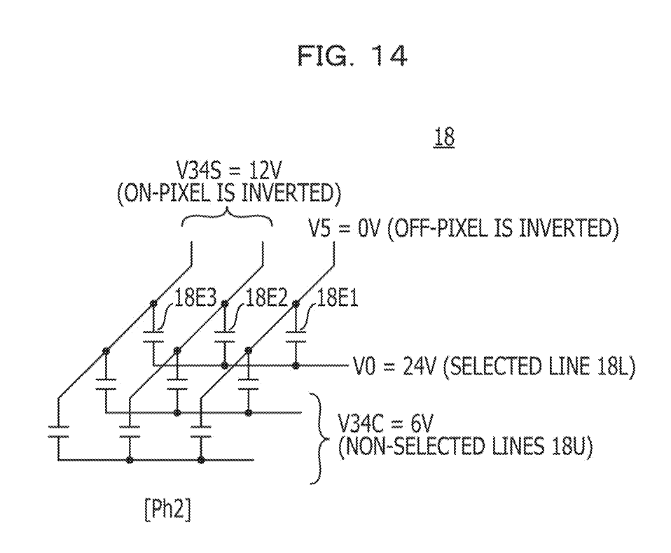

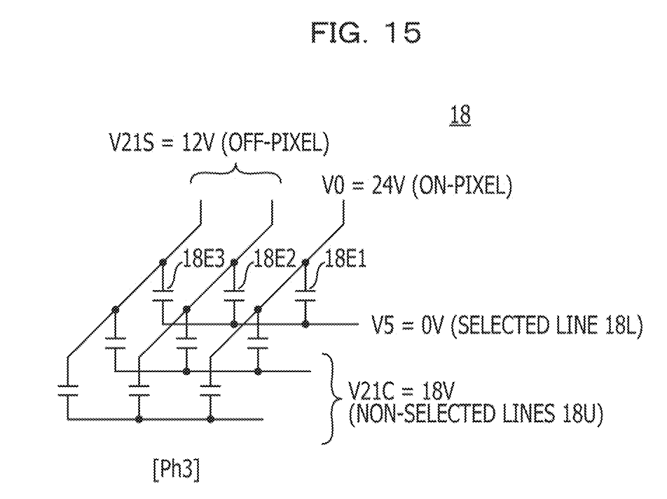

FIG. 12 is a timing chart illustrating an operation performed in the display device 1. In addition, FIG. 13 is a diagram illustrating the display element section 18 in a first phase, FIG. 14 is a diagram illustrating the display element section 18 in a second phase, and FIG. 15 is a diagram illustrating the display element section 18 in a third phase. In addition, in FIGS. 13 to 15, as a matter of convenience in description, it may be assumed that the display element section 18 has a structure in which 3×3 display elements 18E are disposed in a matrix.

FIG. 12 illustrates the pulse polarity control signal FR, the data latch/scan shift signal LPSEG, the image data DATA, the switching control signal CNT, a voltage Vcom applied to the display element section 18 by the common driver 17, a voltage Vseg applied to the display element section 18 by the segment driver 16, and a voltage Vust applied to the non-selected region 181 in the display element section 18. The output voltage Vcom from the common driver 17 is 6 V for the non-selected region 181. In addition, the output voltage Vseg from the segment driver 16 is 24 V for an on-pixel.

First, as illustrated in FIG. 12, in a first phase Ph1, the supply of drive voltages from the multiple voltage generation section 13, namely, the application of voltages to the drivers 16 and 17 is started in a condition that the pulse polarity control signal FR=Low (setting for negative polarity). In the first phase Ph1, the segment driver 16 applies a voltage V5=0 V to a display element 18E that is turned on (ON), and applies a voltage V34S=12 V to a display element 18E that is turned off (OFF). The common driver 17 applies a voltage V0=24 V to the selected line 18L, and applies a voltage V34C=6 V to a non-selected line 18U (namely, the non-selected region 181), thereby charging the display pixel 18E in the non-selected region 181 using voltages of ±6 V.

FIG. 13 is a diagram illustrating an example of application of a voltage in the first phase Ph1. The selected line 18L is one line, and the remaining lines are the non-selected lines 18U. A voltage of −24 V=0 V−24 V is applied to the display element 18E to be turned on (referred to as “on-pixel”, hereinafter), and a voltage of −12 V=0 V−12 V is applied to a display element to be turned off (referred to as “off-pixel”, hereinafter). In addition, a voltage of −6 V=0 V−6 V or a voltage of +6 V=12 V−6 V is applied to the display element 18E in the remaining non-selected lines 18U. In FIG. 13, for example, the display element 18E1 is an on-pixel, and the display elements 18E2 and 18E3 are off-pixels. According to the configuration of the multiple voltage generation section 13 illustrated in FIG. 11, a voltage supplied to the display element 18E in the non-selected line 18U turns out to be based on a drive voltage output from the amplification circuit (namely, an operational amplifier) 1320 driven using the power-supply voltage V2 from the power source that has the low voltage of 13 V. Namely, using the power-supply voltage V2 of 13 V, the non-selected pixels 18E2 and 18E3 are charged with voltages of ±6 V. After a voltage application time during which a voltage that has a negative polarity and is normal is applied to the display element section 18 elapses, a voltage application operation makes the transition to a second phase Ph2.

Next, as illustrated in FIG. 12, the voltage application operation makes the transition from the first phase Ph1 to the second phase Ph2. As a control operation performed at the time of transition to the second phase Ph2, the ON/OFF state of the image data DATA, namely, the polarity thereof, is inverted in the inverting circuit section in response to the switching control signal CNT, and the image data DATA is supplied to the segment driver 16. In the same way as in the first phase Ph1, the pulse polarity control signal FR remains in a setting for negative polarity. Owing to the polarity inversion of the image data DATA, the polarity of the output voltage of the segment driver 16 becomes opposite to that thereof in the first phase Ph1. As a result, the polarities of voltages of ±6 V applied to the display element 18E in the non-selected line 18U in the first phase Ph1 also becomes opposite polarities. Namely, in the second phase Ph2 in FIG. 12, a voltage of −6 V is applied to the display element 18E pixel to which a voltage of 6 V has been applied in the phase Ph1 in FIG. 12, and, in the second phase Ph2, a voltage of +6 V is applied to the display element 18E to which a voltage of −6 V has been applied in the phase Ph1. In this way, the polarities of voltages applied to the non-selected pixels are inverted between the first phase Ph1 and the second phase Ph2. In addition, a voltage is also applied to the selected line 18L, a voltage of 12 V is applied to an inverted pixel that is an on-pixel, and a voltage of 24 V is applied to an inverted pixel that is an off-pixel. In this regard, however, since the electrodes of the display elements 18E are connected to one another in the display element section 18 that has a simple matrix structure, the voltage of the inverted pixel does not reach 12 V or 24 V until all display elements 18E in the non-selected line 18U are charged at up to +6 V or −6 V. Since the setting for polarity remains negative polarity, the power source that has the low voltage of 13 V is used for charging non-selected pixels with voltages of ±6 V, in an operational amplifier power source.

FIG. 14 is a diagram illustrating an example of application of a voltage in the second phase Ph2. In FIG. 14, the same symbol is assigned to the same portion as that in FIG. 13, and the description thereof will be omitted. In FIG. 14, the display elements 18E1 and 18E2 are off-pixels, and the display element 18E3 is an on-pixel. The polarity inversion of a voltage of +6 V applied to the display elements 18E in the non-selected lines 18U is intended in the second phase Ph2, and a voltage application operation makes the transition to a third phase Ph3 after positive polarity electric charge for the non-selected region 181 is completed. Accordingly, the on-pixel and the off-pixels in the selected line 18L make the transition to the third phase Ph3 without a voltage that is more than or equal to +6 V being applied to the on-pixel and the off-pixels.

Next, as illustrated in FIG. 12, the voltage application operation makes the transition from the second phase Ph2 to the third phase Ph3. As a control operation performed at the time of transition to the third phase Ph3, the ON/OFF state of the image data DATA, namely, the polarity thereof, is inverted again in the inverting circuit section in response to the switching control signal CNT, and the image data DATA is supplied to the segment driver 16. The pulse polarity control signal FR is switched to a setting for positive polarity. In the third phase Ph3, owing to the polarity re-inversion of the image data DATA, the polarity of the image data DATA returns to an original polarity. In addition, the image data DATA in the third phase Ph3 differs from the image data DATA in the first phase Ph1 in that the setting of the image data DATA switches from a setting for negative polarity to a setting for positive polarity owing to the pulse polarity control signal FR. At this time, the segment driver 16 applies the voltage V0=24 V to an on-pixel, and applies the voltage V21S=12 V to an off-pixel. The common driver 17 applies the voltage V5=0 V to the selected line 18L, and applies the voltage V21C=18 V to the non-selected line 18U.

FIG. 15 is a diagram illustrating an example of application of a voltage in the third phase Ph3. In FIG. 15, the same symbol is assigned to the same portion as those in FIGS. 13 and 14, and the description thereof will be omitted. In FIG. 15, the display element 18E1 is an on-pixel, and the display elements 18E2 and 18E3 are off-pixels. In the third phase Ph3, a voltage of 24 V=24 V−0 V is applied to an on-pixel, and a voltage of 12 V=12 V−0 V is applied to an off-pixel. In addition, a voltage of +6 V=24 V−18 V or a voltage of −6 V=12 V−18 V is applied to pixels in the remaining non-selected lines 18U. Since the display elements 18E in the non-selected lines 18U have been charged in the second phase Ph2, the non-selected line 18Us hold (or maintain) a voltage of +6 V, and the display elements 18E in the non-selected lines 18U are not charged. In a time period in the voltage Vust, enclosed with a circle T as illustrated in FIG. 12, the display elements 18E in the non-selected lines 18U are charged with a voltage of +6 V. Accordingly, in the third phase Ph3, a voltage applied to one line that is the selected line 18L is based on a drive voltage output from the amplification circuit (namely, an operational amplifier) 1320 that is driven using the power-supply voltage V1 from the power source that has the high voltage of 25 V. In this way, since the selected line 18L driven at a time is one line, a load due to driving is relatively small compared with a driving method of the related art.

Finally, after a voltage application time during which a voltage has a positive polarity and is normal elapses, a line to be scanned next is selected as the selected line 18L, and the processing operation returns to the first phase Ph1. Afterward, in substantially the same way, every time each selected line 18L is selected, the above-described first phase Ph1 to third phase Ph3 are repeated.

In the embodiment, when the processing operation makes the transition from the first phase Ph1 to the third phase Ph3, the processing operation is routed through the second phase Ph2. In the second phase Ph2, charging of the display elements 18E in the non-selected lines 18U, which is to be performed in the following third phase Ph3, is preliminarily performed. Since the multiple voltage generation section 13 includes the voltage supply circuit that has the above-described configuration, processing operations performed in the first phase Ph1 and the second phase Ph2 is based on a drive voltage output from the amplification circuit (namely, an operational amplifier) 1320 driven using the power-supply voltage V2 from the power source that has the low voltage of 13 V. In addition, a processing operation based on a drive voltage output from the amplification circuit (namely, an operational amplifier) 1320 driven using the power-supply voltage V1 from the power source that has the high voltage of 25 V is performed for the selected line 18L in the third phase Ph3. In this way, a processing operation performed for many of the display elements 18E in the display element section 18 is based on a drive voltage output from the amplification circuit (namely, an operational amplifier) 1320 driven using the power-supply voltage V2 from the power source that has the low voltage. Therefore, the power consumption of the display device 1 can be reduced compared with a driving method of the related art.

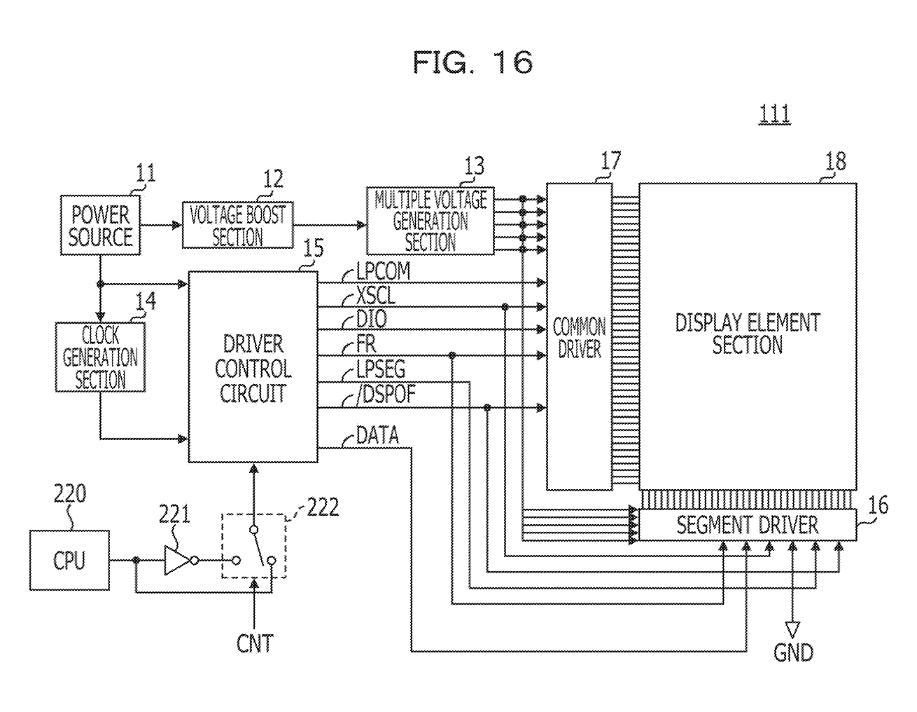

FIG. 16 is a block diagram illustrating an example of a display device in another embodiment of the present invention. In FIG. 16, the same symbol is assigned to the same portion as that in FIG. 1, and the description thereof will be omitted.

In a display device 111 illustrated in FIG. 16, a CPU 220 is provided as a host device, and, in place of the inverting circuit in FIG. 1, an inverting circuit section formed by an inverter circuit 221 and a switch circuit 222 is provided. In response to a switching control signal CNT that is input to the switch circuit 222 from the driver control circuit 15, the CPU 220, or the like, the inverting circuit section causes image data to be input to the segment driver 16 through the driver control circuit 15 without or with the polarity of the image data being inverted. As described above, the inverting circuit section causes the display element to be charge by inverting the polarity of image data supplied to the display element section 18, in a time between application of a negative polarity voltage to the display element section 18 and application of a positive polarity voltage to the display element section 18, and inverts again the polarity of the image data. The operation timing of the display device 111 is the same as that described with reference to FIG. 12.

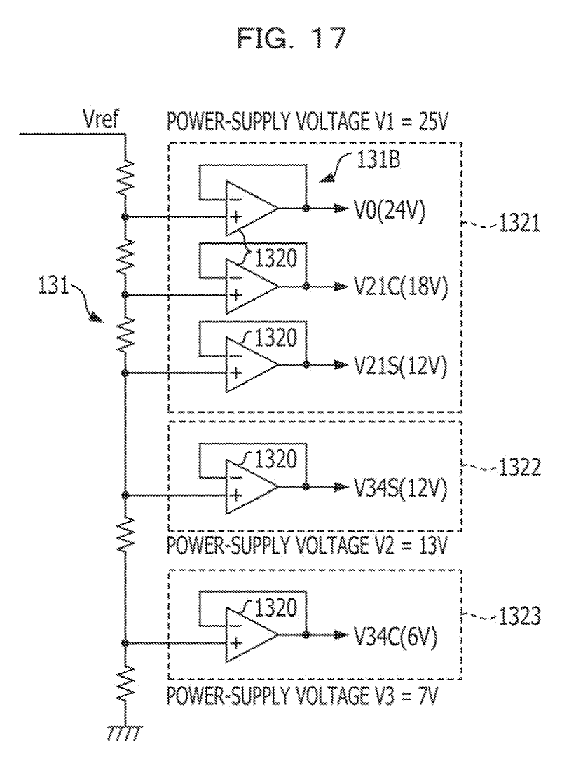

FIG. 17 is a diagram for explaining another example of the multiple voltage generation section 13. In FIG. 17, the same symbol is assigned to the same portion as that in FIG. 11, and the description thereof will be omitted.

FIG. 17 illustrates a voltage supply circuit that generates various kinds of voltages on the basis of the reference voltage Vref from the voltage boost section 12, in the multiple voltage generation section 13. The voltage supply circuit includes a resistance group 131 and an amplification circuit group 131B that includes amplification circuit sections 1321, 1322, and 1323. The amplification circuit sections 1321, 1322, and 1323 include a plurality of amplification circuits 1320 that are connected to nodes that connect adjacent resistances in the resistance group 131. Each amplification circuit 1320 is formed using an operational amplifier.

The operational amplifier 1320 (namely, an operational amplifier) in the amplification circuit section 1321 is driven using a power-supply voltage V1 that has, for example, a voltage of 25 V. In addition, the operational amplifier 1320 (namely, an operational amplifier) in the amplification circuit section 1322 is driven using a power-supply voltage V2 that has, for example, a voltage of 13 V. Furthermore, the operational amplifier 1320 (namely, an operational amplifier) in the amplification circuit section 1323 is driven using a power-supply voltage V3 that has, for example, a voltage of 7 V. The power-supply voltages V1, V2, and V3 (V1>V2>V3) are supplied from power sources different from one other. The amplification circuit section 1321 outputs drive voltages V0=24 V, V21C=18 V, and V21S=12 V. The amplification circuit section 1322 outputs a drive voltage V34S=12 V and, the amplification circuit section 1323 outputs a drive voltage V34C=6 V.

In this way, in the multiple voltage generation section 13 in FIG. 17, as power sources for driving amplification circuits (namely, operational amplifiers) 1320 in the amplification circuit group 131B, three separate power sources that have a high voltage of 25 V, a middle voltage of 13 V, and a low voltage of 7 V, respectively are used. While, in this example, the voltages of the three types of power-supply voltages are 25 V, 13 V, and 7 V in view of a margin for drive voltages, the voltage values thereof are not limited to the example. When a so-called rail-to-rail type operational amplifier that can output a voltage ranging to the power-supply voltage is used, three types of power-supply voltages in a case in which the drive voltages V0, V21C, V21S, V34S, and V34C, the voltage values of which are as mentioned above, are output may be, for example, 24 V, 12 V, and 6 V. In this way, the number of the amplification circuit sections in the amplification circuit group, namely, the number of power sources used for driving the amplification circuit sections in the amplification circuit group, is not limited to two, and may be more than or equal to three.

In addition, it should be understood that if the voltage values of the voltages V0, V21S, V21C, V34S, V34C, and V5 meet the relation described above, the voltage values of the voltages V0, V21S, V21C, V34S, V34C, and V5 are not limited to the voltages cited in the individual embodiments.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments in accordance with aspects of the present inventions have been described in detail, it should be understood that various changes, substitutions, and alterations could be made hereto without departing from the spirit and scope of the invention.

What is claimed is:

1. A driving method of a display device comprising:
supplying a first drive voltage from a first circuit, which is driven using a first power-supply voltage from a first power source, and a second drive voltage from a second circuit, which is driven using a second power-supply voltage from a second power source that is lower than the first power-supply voltage;
causing a driver circuit section that drives a display element to charge, using the second drive voltage, a display element in a non-selected region in a display element section that includes a plurality of display elements;
maintaining a voltage of the display element in the non-selected region, using the second drive voltage;
charging the display element by firstly inverting a polarity of image data supplied to the display element section, in a time between application of a negative polarity voltage to the display element section and application of a positive polarity voltage to the display element section; and
secondly inverting the polarity of the image data firstly inverted.

2. The driving method of the display device according to claim 1, wherein
the application of the negative polarity voltage is executed before the application of the positive polarity voltage.

3. The driving method of the display device according to claim 2, wherein
the image data the polarity of which is firstly inverted is being applied to the display element section until charging of the display element in the non-selected region is completed.

4. The driving method of the display device according to claim 2, wherein
a positive polarity drive voltage is supplied to the driver circuit section when the polarity of the image data firstly inverted is secondly inverted.

5. The driving method of the display device according to claim 2, wherein
a time of the application of the positive polarity voltage to the display element section performed by the driver circuit section is shorter by a time, which corresponds to a time of supply of the image data firstly inverted to the display element section, than a time of the application of the negative polarity voltage.

6. A display device comprising:
a display element section including display elements disposed in a matrix;
a driver circuit section to drive the display element section on a basis of image data and a first drive voltage;
a voltage supply circuit including a first circuit, which is driven using a first power-supply voltage from a first power source, and a second circuit, which is driven using a second power-supply voltage from a second power source that is lower than the first power-supply voltage, and to supply the first drive voltage to the driver circuit section; and
an inverting circuit section to input the image data to the driver circuit section,
the driver circuit section charges, using a second drive voltage from the second circuit, a display element in a non-selected region in the display element section, and maintains a voltage of the display element in the non-selected region, using the second drive voltage; and
the inverting circuit section charges the display element for which a polarity of the image data supplied to the display element section is firstly inverted, in a time between application of a negative polarity voltage to the display element section and application of a positive polarity voltage to the display element section, and secondly inverts the polarity of the image data firstly inverted.

7. The display device according to claim 6, wherein
the voltage supply circuit supplies the drive voltage to the driver circuit section so that the application of the negative polarity voltage is executed before the application of the positive polarity voltage.

8. The display device according to claim 7, wherein
the inverting circuit section is applying the image data the polarity of which is firstly inverted to the display element section until charging of the display element in the non-selected region is completed.

9. The display device according to claim 7, wherein
the voltage supply circuit supplies a positive polarity drive voltage to the driver circuit section when the inverting circuit section secondly inverts the polarity of the image data firstly inverted.

10. The display device according to claim 7, wherein
a time of the application of the positive polarity drive voltage to the display element section performed by the driver circuit section is shorter by a time, which corresponds to a time of supply of the image data firstly inverted to the display element section, than a time of the application of the negative polarity drive voltage.

11. The display device according to claim 6, wherein
the display element section includes a cholesteric liquid crystal.
